(19) United States
(12) Patent Application Publication
(10) Pub. No.: US 2021/0374991 A1
(43) Pub. Date: Dec. 2, 2021

(54) METHOD, SYSTEM AND NON-TRANSITORY COMPUTER-READABLE RECORDING MEDIUM FOR SUPPORTING OBJECT CONTROL

(71) Applicant: VTOUCH CO., LTD., Seoul (KR)

(72) Inventor: Seok Joong KIM, Seoul (KR)

(73) Assignee: VTOUCH CO., LTD., Seoul (KR)

(21) Appl. No.: 17/400,894

(22) Filed: Aug. 12, 2021

Related U.S. Application Data
(63) Continuation of application No. PCT/KR2020/000967, filed on Jan. 20, 2020.

(30) Foreign Application Priority Data
Feb. 13, 2019 (KR) 10-2019-0016941

(51) Int. Cl. G06T 7/73; G06K 9/00; G06F 3/01; G01B 11/02

(52) U.S. Cl. CPC G06T 7/74; G06K 9/00369; G06T 2207/30196; G01B 11/026; G06K 9/00375; G06F 3/017

(57) ABSTRACT

A method includes acquiring a two-dimensional image relating to a user's body from a two-dimensional camera; calculating three-dimensional real-world coordinates corresponding to at least one body portion among a plurality of body portions of the user, which are specified from the two-dimensional image; estimating, with reference to the three-dimensional real-world coordinates corresponding to the at least one body portion, three-dimensional real-world coordinates respectively corresponding to first and second body portions used in determining the user's intention; and determining a control target area with reference to a first candidate target area specified based on the three-dimensional real-world coordinates respectively corresponding to the first and second body portions, and a second candidate target area specified based on two-dimensional relative coordinates respectively corresponding to the first and second body portions in the two-dimensional image. The control target area is determined on a reference plane established with the two-dimensional camera as a reference.

### CROSS-REFERENCE TO RELATED APPLICATION

This application is a continuation application of Patent Cooperation Treaty (PCT) International Application No. PCT/KR2020/000967 filed on Jan. 20, 2020, which claims priority to Korean Patent Application No. 10-2019-0016941 filed on Feb. 13, 2019. The entire contents of PCT International Application No. PCT/KR2020/000967 and Korean Patent Application No. 10-2019-0016941 are hereby incorporated by reference.

### TECHNICAL FIELD

The present disclosure relates to a method, a system, and a non-transitory computer-readable recording medium for assisting object control.

### BACKGROUND

In recent years, as interest in augmented reality (AR) or virtual reality (VR) is increasing and research and development in related technical fields are actively carried out, a variety of techniques for controlling an object using a user's body portion have been introduced.

In this regard, Korean Laid-Open Patent Publication No. 10-2012-126508 can be provided as an example of conventional techniques. According to this publication, there has been introduced a method of recognizing a touch in a virtual touch device without using a pointer, wherein the virtual touch device comprises: an image acquisition unit composed of two or more image sensors disposed at different positions and configured to capture an image of a user's body in front of a display plane; a spatial coordinate calculation unit configured to calculate three-dimensional coordinate data of the user's body using the image received from the image acquisition unit; a touch position calculation unit configured to calculate, by using first and second spatial coordinates received from the spatial coordinate calculation unit, coordinate data of a contact point where a straight line connecting the first and second spatial coordinates meets the display plane; and a virtual touch processing unit configured to generate a command code for performing an operation set to correspond to the contact point coordinate data received from the touch position calculation unit, and input the command code to a main control unit of the device, and wherein the method comprises the steps of: (A) processing three-dimensional coordinate data (X1, Y1, Z1) of a fingertip and three-dimensional coordinate data (X2, Y2, Z2) of a center point of an eye to detect a contact point A of a display plane C, a fingertip point B, and the eye, respectively; (B) calculating at least one of a depth change, a trajectory change, a retention time, and a change rate of the detected fingertip point B; and (C) selecting a certain region of a touch panel as if touching the certain portion and operating the device, based on the at least one of the depth change, the trajectory change, the retention time, and the change rate of the calculated fingertip point.

According to the techniques introduced so far as well as the above-described conventional technique, a process of acquiring three-dimensional coordinates of a user's body portion using a three-dimensional camera is necessarily required in order to select or control an object. However, a three-dimensional camera is not only expensive but also has a lot of delays occurring in the course of processing three-dimensional data. An arithmetic processing unit (central processing unit, CPU) or the like with higher performance is required to address such delays, resulting in a higher overall price.

In this connection, the inventors of the present disclosure propose a novel and advanced technique capable of accurately selecting or controlling a target object that accords with a user's intention in an efficient manner only using a conventional two-dimensional camera, without a three-dimensional camera.

### SUMMARY

One object of the present disclosure is to solve all the above-described problems.

Another object of the present disclosure is to accurately determine a control target area that accords with a user's intention based on information acquired by using a two-dimensional camera without using a three-dimensional camera, and three-dimension information calculated for at least one body portion of the user.

Yet another object of the present disclosure is to efficiently determine a control target area using a small amount of resources.

Representative configurations of the present disclosure to achieve the above objects are described below.

According to one aspect of the present disclosure, there is provided a method of assisting an object control, comprising the steps of: acquiring a two-dimensional image relating to a user's body from a two-dimensional camera; calculating three-dimensional real-world coordinates corresponding to at least one body portion among a plurality of body portions of the user, which are specified from the two-dimensional image; estimating, with reference to the three-dimensional real-world coordinates corresponding to the at least one body portion, three-dimensional real-world coordinates respectively corresponding to a first body portion and a second body portion that are used in determining the user's intention among the plurality of body portions; and determining a control target area with reference to a first candidate target area specified based on the three-dimensional real-world coordinates respectively corresponding to the first body portion and the second body portion, and a second candidate target area specified based on two-dimensional relative coordinates respectively corresponding to the first body portion and the second body portion in the two-dimensional image; wherein the control target area is determined on a reference plane established with the two-dimensional camera as a reference.

According to another aspect of the present disclosure, there is provided a system for assisting an object control, comprising: an image acquisition unit configured to acquire a two-dimensional image relating to a user's body from a two-dimensional camera; a coordinate estimation unit configured to calculate three-dimensional real-world coordinates corresponding to at least one body portion among a plurality of body portions of the user, which are specified from the two-dimensional image, and configured to estimate, with reference to the three-dimensional real-world coordinates corresponding to the at least one body portion, three-dimensional real-world coordinates respectively corresponding to a first body portion and a second body portion that are used in determining the user's intention among the plurality of body portions; and a control target area determination unit configured to determine a control target area with reference to a first candidate target area specified based on the three-dimensional real-world coordinates respectively corresponding to the first body portion and the second body portion, and a second candidate target area specified based on the two-dimensional relative coordinates respectively corresponding to the first body portion and the second body portion in the two-dimensional image; wherein the control target area is determined on a reference plane established with the two-dimensional camera as a reference.

In addition, there are further provided other methods and systems to implement the present disclosure, as well as non-transitory computer-readable recording media having stored thereon computer programs for executing the methods.

According to the present disclosure, it is possible to accurately determine a control target area that accords with a user's intention based on information obtained by using a two-dimensional camera without using a three-dimensional camera, and three-dimensional information calculated for at least one body portion of the user.

According to the present disclosure, it is possible to efficiently determine a control target area using a small amount of resources.

### BRIEF DESCRIPTION OF THE DRAWINGS

FIG. 1 illustratively shows a detailed internal configuration of an object control assistance system according to one embodiment of the present disclosure.

FIG. 2 illustratively shows a process of estimating three-dimensional real-world coordinates of a body portion that accords with a user's intention according to one embodiment of the present disclosure.

FIG. 3 illustratively shows a process of determining a candidate target area and a control target area according to one embodiment of the present disclosure.

FIG. 4 illustratively shows a process of determining a candidate target area and a control target area according to one embodiment of the present disclosure.

FIG. 5A illustratively shows a process of determining the control target area using an object control assistance system according to one embodiment of the present disclosure.

FIG. 5B illustratively shows a process of determining the control target area using an object control assistance system according to one embodiment of the present disclosure.

### DETAILED DESCRIPTION

In the following detailed description of the present disclosure, references are made to the accompanying drawings that show, by way of illustration, specific embodiments in which the present disclosure may be practiced. These embodiments are described in sufficient detail to enable those skilled in the art to practice the present disclosure. It is to be understood that the various embodiments of the present disclosure, although different from each other, are not necessarily mutually exclusive. For example, specific shapes, structures, and features described herein may be implemented as modified from one embodiment to another without departing from the spirit and scope of the present disclosure. Furthermore, it shall be understood that the positions or arrangements of individual elements within each of the embodiments may also be modified without departing from the spirit and scope of the present disclosure. Therefore, the following detailed description is not to be taken in a limiting sense, and the scope of the present disclosure is to be taken as encompassing the scope of the appended claims and all equivalents thereof. In the drawings, like reference numerals refer to the same or similar elements throughout the several views.

Hereinafter, various preferred embodiments of the present disclosure will be described in detail with reference to the accompanying drawings to enable those skilled in the art to easily implement the present disclosure.

Configuration of the Entire System

An entire system according to one embodiment of the present disclosure may include a communication network, an object control assistance system 100, and a two-dimensional camera.

First, the communication network according to one embodiment of the present disclosure may be implemented regardless of communication modality such as wired and wireless communications, and may be constructed from a variety of communication networks such as local area networks (LANs), metropolitan area network (MANs), and wide area networks (WANs). Preferably, the communication network described herein may be the Internet or the World Wide Web (WWW). However, the communication network is not necessarily limited thereto, and may at least partially include known wired/wireless data communication networks, known telephone networks, or known wired/wireless television communication networks.

For example, the communication network may be a wireless data communication network, at least a portion of which may be implemented with a conventional communication scheme, such as radio frequency (RF) communication, WiFi communication, cellular communication (e.g., Long Term Evolution (LTE) communication), Bluetooth communication (more specifically, Bluetooth Low Energy (BLE) communication), infrared communication, and ultrasonic communication.

Next, the object control assistance system 100 according to one embodiment of the present disclosure may be a digital device having a memory means and a microprocessor for computing capabilities. The object control assistance system 100 may be a server system.

According to one embodiment of the present disclosure, the object control assistance system 100 may be coupled to a two-dimensional camera described later via the communication network or a certain processor (not shown), and may perform a function of: acquiring a two-dimensional image relating to a user's body from the two-dimensional camera; calculating three-dimensional real-world coordinates corresponding to at least one body portion among a plurality of body portions of the user, which are specified from the acquired two-dimensional image; estimating three-dimensional real-world coordinates respectively corresponding to a first body portion and a second body portion which are used in determining the user's intention among the plurality of body portions of the user, with reference to the three-dimensional real-world coordinates corresponding to the at least one body portion; and determining a control target area with reference to a first candidate target area that is specified based on the three-dimensional real-world coordinates respectively corresponding to the first body portion and the second body portion, and a second candidate target area that is specified based on two-dimensional relative coordinates respectively corresponding to the first body portion and the second body portion in the two-dimensional image.

The two-dimensional relative coordinates according to one embodiment of the present disclosure may be coordinates specified in a relative coordinate system associated with the two-dimensional camera. For example, according to one embodiment of the present disclosure, a two-dimensional coordinate system specified with a lens of the two-dimensional camera as a reference (e.g., a center of the lens is (0, 0)), may be specified as the relative coordinate system and the two-dimensional relative coordinates may be specified in the relative coordinate system.

Further, according to one embodiment of the present disclosure, examples of the body portions may include a head, eyes, a nose, a mouth, hands, fingertips, fingers, feet, tiptoe, toes, and the like, but are not limited to the body portions described above and the body portions may be changed to other various body portions as long as the objects of the present disclosure can be achieved.

Furthermore, according to one embodiment of the present disclosure, the control target area may be determined on a reference plane established with the two-dimensional camera as a reference. According to one embodiment of the present disclosure, the reference plane established with the two-dimensional camera as a reference may include a plane of a predetermined size that is established with the two-dimensional camera as a reference or a plane of a predetermined size that is existed at a position adjacent (or within a predetermined distance) to the two-dimensional camera. The reference plane may be a flat plane or a curved plane, and may include a display screen, a printed paper sheet, a wall, and the like.

The configuration and functions of the object control assistance system 100 according to one embodiment of the present disclosure will be described in more detail below. Meanwhile, although the object control assistance system 100 has been described as above, such a description is illustrative and it will be apparent to those skilled in the art that at least a portion of functions or components required for the object control assistance system 100 may be implemented or included in an external system (not shown), as necessary.

Next, the two-dimensional camera according to one embodiment of the present disclosure may communicate with the object control assistance system 100 by means of the communication network or a certain processor, and may perform a function of acquiring a two-dimensional image relating to the user's body. For example, the two-dimensional camera according to one embodiment of the present disclosure may include various types of image sensors, such as a charge coupled device (CCD), a complementary metal oxide semiconductor (CMOS), and the like.

Configuration of Object Control Assistance System

An internal configuration of the object control assistance system 100 crucial for implementing the present disclosure and functions of the respective elements thereof will be described.

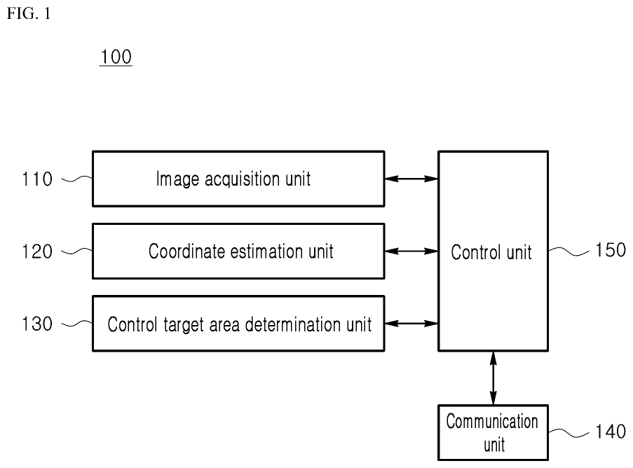

FIG. 1 illustratively shows a detailed internal configuration of the object control assistance system 100 according to one embodiment of the present disclosure.

As shown in FIG. 1, the object control assistance system 100 may include an image acquisition unit 110, a coordinate estimation unit 120, a control target area determination unit 130, a communication unit 140, and a control unit 150. According to one embodiment of the present disclosure, at least some of the image acquisition unit 110, the coordinate estimation unit 120, the control target area determination unit 130, the communication unit 140, and the control unit 150 may be program modules to communicate with an external system. Such program modules may be included in the object control assistance system 100 in the form of operating systems, application program modules, and other program modules, while they may be physically stored in a variety of commonly known storage devices. Further, the program modules may also be stored in a remote storage device that may communicate with the object control assistance system 100. Meanwhile, such program modules may include, but not limited to, routines, subroutines, programs, objects, components, data structures, and the like for performing specific tasks or executing specific abstract data types as will be described below according to the present disclosure.

The image acquisition unit 110 according to one embodiment of the present disclosure may function to acquire a two-dimensional image relating to the user's body from the two-dimensional camera.

For example, the image acquisition unit 110 according to one embodiment of the present disclosure may acquire a two-dimensional image relating to the body, which includes the user's eyes (e.g., both eyes or a dominant eye) and fingers (e.g., a fingertip of an index finger).

The coordinate estimation unit 120 according to one embodiment of the present disclosure may calculate three-dimensional real-world coordinates corresponding to at least one body portion among a plurality of body portions of the user, which are specified from the two-dimensional image relating to the user's body.

As an example, the coordinate estimation unit 120 according to one embodiment of the present disclosure may calculate the three-dimensional real-world coordinates corresponding to the at least one body portion, with reference to a focal length of a lens of the two-dimensional camera, which is associated with the at least one body portion among the plurality of the body portions of the user specified from the two-dimensional image.

More specifically, the coordinate estimation unit 120 according to one embodiment of the present disclosure may move the lens of the two-dimensional camera to specify a point at which an image of the at least one body portion becomes clear or noticeable as the focal length of the respective body portion. Further, the coordinate estimation unit 120 may calculate information about a distance between the two-dimensional camera and the at least one body portion by using a relationship between at least two of the specified focal length, an angle of view for the at least one body portion, and a length of an image sensor (or a film) of the two-dimensional camera. Then, the coordinate estimation unit 120 according to one embodiment of the present disclosure may calculate the three-dimensional real-world coordinate corresponding to the at least one body portion with reference to the information about the calculated distance information and the two-dimensional relative coordinate of the at least one body portion specified in the two-dimensional image.

As another example, the coordinate estimation unit 120 according to one embodiment of the present disclosure may calculate the three-dimensional real-world coordinates corresponding to at least one body portion with reference to a measurement distance between the two-dimensional camera and the at least one body portion among the plurality of body portions of the user specified from the two-dimensional image.

More specifically, first, the coordinate estimation unit 120 according to one embodiment of the present disclosure may estimate information about a distance between the two-dimensional camera and the at least one body portion with reference to information obtained from at least one distance measuring sensor that calculates a distance using at least one of ultrasound, infrared ray, LiDAR, and RADAR. Then, the coordinate estimation unit 120 according to one embodiment of the present disclosure may calculate the three-dimensional real-world coordinate corresponding to the at least one body portion with reference to the information about the estimated distance and the two-dimensional relative coordinates of the at least one body portion specified in the two-dimensional image.

As yet another example, the coordinate estimation unit 120 according to one embodiment of the present disclosure may calculate the three-dimensional real-world coordinate corresponding to the at least one body portion among the plurality of body portions of the user which are specified from the two-dimensional image, with reference to information about at least one of a length, a size, and a pixel of at least one object included in the two-dimensional image.

More specifically, the coordinate estimation unit 120 according to one embodiment of the present disclosure may specify, among objects included in the two-dimensional image, an object whose information about at least one of an actual length, an actual size, and a pixel size of the two-dimensional camera previously exists in a database (or a lookup table). Further, the coordinate estimation unit 120 may calculate the three-dimensional real-world coordinates corresponding to the at least one body portion by comparing the actual length and the actual size of the specified object, and the pixel size in the two-dimensional camera, with the length and the size of the respective object and the pixel size in the two-dimensional image.

Further, the coordinate estimation unit 120 according to one embodiment of the present disclosure may estimate three-dimensional real-world coordinates respectively corresponding to the first body portion and the second body portion that accord with the user's intention among the plurality of body portions, with reference to the three-dimensional real-world coordinates corresponding to the at least one body portion.

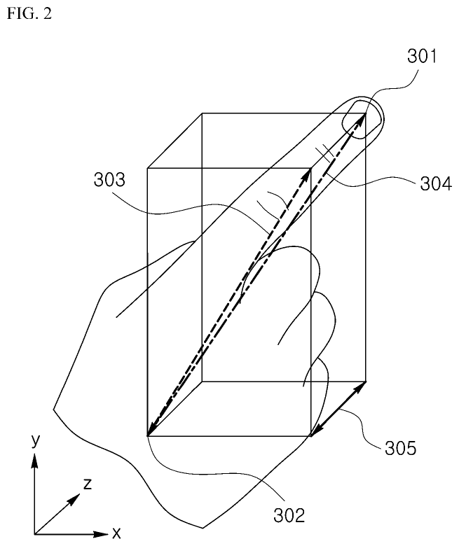

As an example, referring to FIG. 2, in one embodiment of the present disclosure, the first and the second body portions used in determining the user's intention may be the user's eye (e.g., the dominant eye) and the user's fingertip 301 (e.g., the fingertip of the index finger), respectively, and the user's body portion used in calculating the three-dimensional real-world coordinates by the process described above may be a center 302 of the user's fist. In this case, the coordinate estimation unit 120 according to one embodiment of the present disclosure may specify a two-dimensional straight distance 303 (i.e., a straight distance on an x-y plane) between the user's fingertip 301 and the center 302 of the user's fist in the two-dimensional image. Then, the coordinate estimation unit 120 according to one embodiment of the present disclosure may specify a three-dimensional distance 304 between the user's fingertip 301 and the center 302 of the fist with reference to a model associated with an inter-body physical distance. Subsequently, the coordinate estimation unit 120 according to one embodiment of the present disclosure may estimate three-dimensional real-world coordinates of the user's fingertip 301 with reference to the three-dimensional distance 304 between the user's fingertip 301 and the center 302 of the user's fist, and the two-dimensional straight distance 303 between the user's fingertip 301 and the center 302 of the user's fist.

Meanwhile, according to one embodiment of the present disclosure, the model associated with the inter-body physical distance described above may be a model that is dynamically specified with reference to user-related information, such as a user's gender, age, race, residence, and the like.

The control target area determination unit 130 according to one embodiment of the present disclosure may determine the control target area with reference to a first candidate target area specified based on the three-dimensional real-world coordinates respectively corresponding to the first body portion and the second body portion, and a second candidate target area specified based on the two-dimensional relative coordinates respectively corresponding to the first body portion and the second body portion in the two-dimensional image. Further, the control target area determination unit 130 according to one embodiment of the present disclosure may determine the control target area on a reference plane established with the two-dimensional camera as a reference.

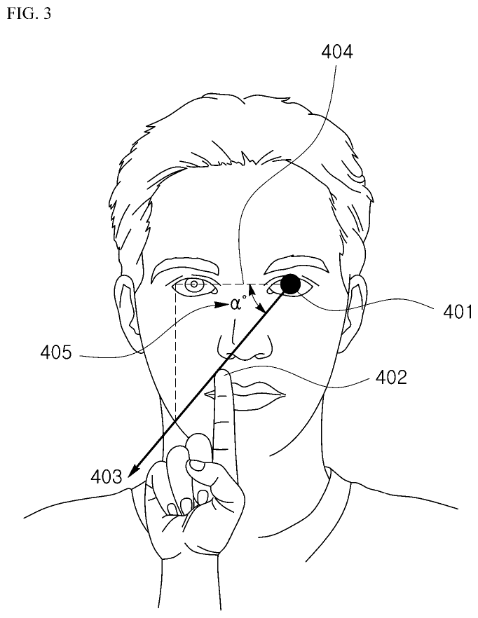

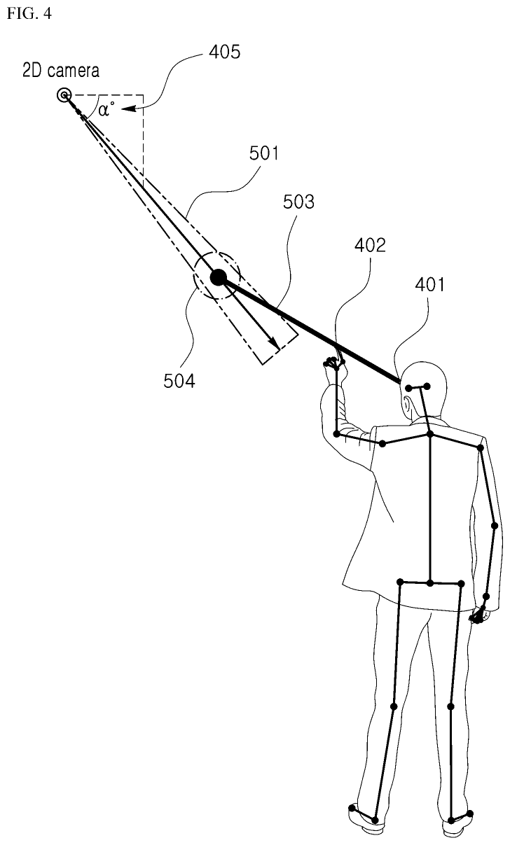

As an example, referring to FIGS. 3 and 4, the second candidate target area according to one embodiment of the present disclosure may be specified by an area between the two-dimensional camera and a virtual point (not shown) set on the reference plane established with the two-dimensional camera as a reference. A positional relationship between the virtual point and the two-dimensional camera may be specified by a positional relationship between two-dimensional relative coordinates respectively corresponding to a first body portion 401 and a second body portion 402 of the user in the two-dimensional image obtained from the two-dimensional camera.

More specifically, the control target area determination unit 130 according to one embodiment of the present disclosure may specify an angle 405 between a line 403 connecting the two-dimensional relative coordinates of the user's eye 401 and the user's fingertip 402 that are specified in the two-dimensional image obtained from the two-dimensional camera, and a reference line 404 preset in the two-dimensional image. Here, according to one embodiment of the present disclosure, the reference line 404 preset in the two-dimensional image may be a horizontal line (or a vertical line) specified by a horizontal axis (or vertical axis) of the two-dimensional image, or a straight line that is parallel to a straight line that connects the user's both eyes in the two-dimensional image. Subsequently, the control target area determination unit 130 according to one embodiment of the present disclosure may set a virtual point which is determined based on the specified angle 405 with the two-dimensional camera as a reference on the reference plane, and may specify an area between the two-dimensional camera and the virtual point as a second candidate target area 501. For example, according to one embodiment of the present disclosure, with the two-dimensional camera as a reference on the reference plane, an area at a position rotated by the angle 405 from a straight line parallel to the reference line 404 preset in the two-dimensional image or a horizontal axis of an object display device 200 (to be described later) may be specified as the virtual point.

Further, the control target area determination unit 130 according to one embodiment of the present disclosure may specify at least one instruction line based on the three-dimensional real-world coordinates respectively corresponding to the first body portion and the second body portion, and may specify the first candidate target area based on the specified at least one instruction line.

More specifically, referring to FIG. 4, the control target area determination unit 130 according to one embodiment of the present disclosure may specify at least one instruction line 503 based on the three-dimensional real-world coordinates respectively corresponding to the user's eye 401 and the user's fingertip 402, and may specify an area that is instructed (or specified) by the at least one instruction line 503 on the reference plane, as a first candidate target area 504.

Further, the control target area determination unit 130 according to one embodiment of the present disclosure may specify an instruction area which corresponds to the three-dimensional real-world coordinates respectively corresponding to the first body portion and the second body portion of the user with reference to a lookup table (not shown) associated with the instruction area corresponding to the three-dimensional real-world coordinates of the body portions (e.g., may specify the instruction area on the reference plane established with the two-dimensional camera as a reference), and specify the instruction area as the first candidate target area 504.

Further, the control target area determination unit 130 according to one embodiment of the present disclosure may determine an area common to the first candidate target area 504 and the second candidate target area 501 specified in the above, as the control target area.

As an example, the control target area determination unit 130 according to one embodiment of the present disclosure may specify, as the control target area, the area common to the first candidate target area 504 and the second candidate target area 501 on the reference plane established with the two-dimensional camera as a reference, and may determine an object included in the control target area as an object to be controlled by the user.

The communication unit 140 according to one embodiment of the present disclosure may function to enable transmission/reception of data with respect to the image acquisition unit 110, the coordinate estimation unit 120, and the control target area determination unit 130.

The control unit 150 according to one embodiment of the present disclosure may function to control the flow of data among the image acquisition unit 110, the coordinate estimation unit 120, the control target area determination unit 130, and the communication unit 140. That is, the control unit 150 according to one embodiment of the present disclosure may control the flow of data into/out of the object control assistance system 100 or data flow among the respective components of the object control assistance system 100, such that the image acquisition unit 110, the coordinate estimation unit 120, the control target area determination unit 130, and the communication unit 140 may carry out their particular functions, respectively.

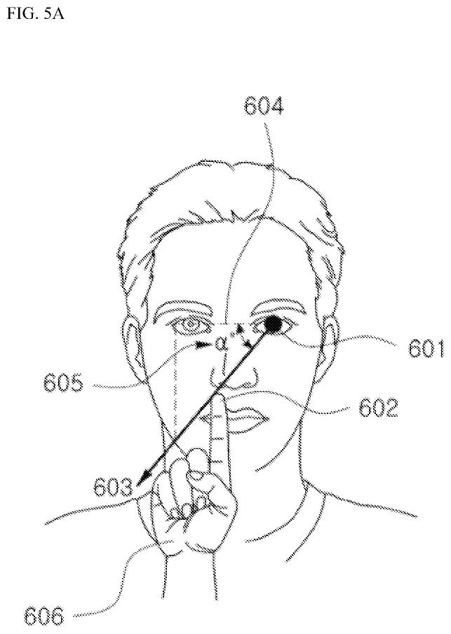

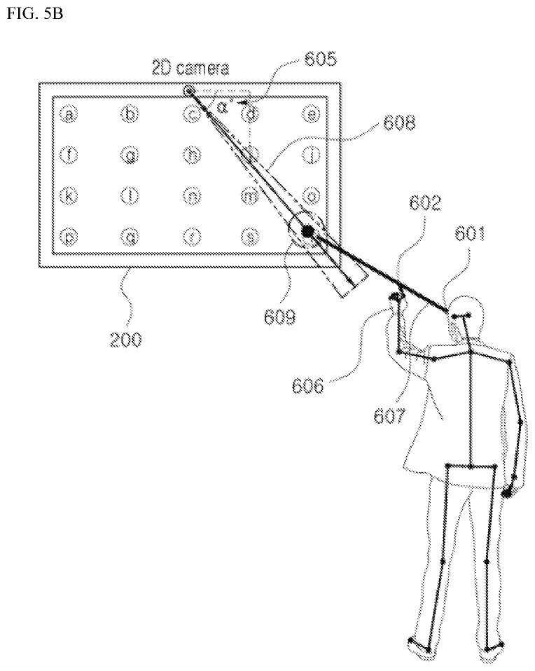

FIGS. 5A and 5B illustratively show a process of determining a control target area by the object control assistance system 100 according to one embodiment of the present disclosure.

Referring to FIGS. 5A and 5B, the two-dimensional camera according to one embodiment of the present disclosure may be included in the object display device 200 (to be described later), and may be positioned adjacent to the object display device 200 if necessary. In this case, in one embodiment of the present disclosure, a display screen of the object display device 200 may be located on the reference plane established with the two-dimensional camera as a reference, or may have a position matched with the two-dimensional camera each other.

Further, in FIG. 5B, it may be assumed that objects “a” to “t” are displayed or printed on the display screen of the object display device 200. In addition, the objects displayed on the object display device 200 according to the present disclosure may be not only displayed electronically but also displayed in various manners such as printing, engraving, and embossing as long as the objects of the present disclosure can be achieved.

Furthermore, the object display device 200 according to one embodiment of the present disclosure may be connected to the object control assistance system 100 via the communication network or a certain processor, and may function to display an object to be controlled by the user thereon. For example, according to one embodiment of the present disclosure, the object display device 200 may include a liquid crystal display (LCD), a thin film transistor LCD (TFT-LCD), a light emitting diode (LED) display, an organic LED (OLED) display, an active matrix OLEO (AMOLED) display, a Retina display, a flexible display, a three-dimensional display, and the like.

Referring to FIG. 5A, a two-dimensional image relating to the user's body may be acquired by using the two-dimensional camera according to one embodiment of the present disclosure.

Next, according to one embodiment of the present disclosure, three-dimensional real-world coordinates corresponding to a center 606 of a fist among a plurality of body portions of the user, which are specified from the acquired two-dimensional image, may be calculated.

Subsequently, according to one embodiment of the present disclosure, three-dimensional real-world coordinates respectively corresponding to the user's eye 601 (e.g., the dominant eye) and the user's fingertip 602 (e.g., the fingertip of an index finger) that accord with the user's intention, may be estimated with reference to the three-dimensional real-world coordinates corresponding to the center 606 of the fist.

According to another embodiment of the present disclosure, in order to increase the accuracy of estimation, three-dimensional real-world coordinates respectively corresponding to the center 606 of the fist and the head portion among the plurality of body portions of the user may be calculated, and three-dimensional real-world coordinates respectively corresponding to the user's eye 601 (e.g., the dominant eye) and the user's fingertip 602 (e.g., the fingertip of the index finger) may be estimated with reference to the three-dimensional real-world coordinates respectively corresponding to the center 606 of the fist and the head portion.

Referring to FIG. 5B, the control target area according to one embodiment of the present disclosure may be determined with reference to a first candidate target area 609 that is specified based on the three-dimensional real-world coordinates respectively corresponding to the user's eye 601 (e.g., the dominant eye) and the user's fingertip 602 (e.g., the fingertip of the index finger), and a second candidate target area 608 that is specified based on two-dimensional relative coordinates respectively corresponding to the user's eye 601 (e.g., the dominant eye) and the user's fingertip 602 (e.g., the fingertip of the index finger) in the two-dimensional image. More specifically, according to one embodiment of the present disclosure, on the reference plane (e.g., on the display screen of the object display device 200) established with the two-dimensional camera as a reference, an area common to the first candidate target area 609 and the second candidate target area 608 which are specified in the above, may be determined as the control target area.

That is, according to one embodiment of the present disclosure, both the object “i” and the object “t” are included in the second candidate target area 608, whereas the object “t” alone is included in the first candidate target area 609, and thus, the object “t” which belongs to the common area may be determined as a control target object that accords with the user's intention.

The embodiments according to the present disclosure as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present disclosure, or may also be known and available to those skilled in the computer software field. Examples of the computer-readable recording medium may include: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions may include not only machine language codes created by a compiler, but also high-level language codes that can be executed by a computer using an interpreter. The above hardware devices may be changed to one or more software modules to perform the processes of the present disclosure, and vice versa.

Although the present disclosure has been described above in terms of specific items such as detailed elements as well as the limited embodiments and the drawings, they are only provided to help more general understanding of the present disclosure, and the present disclosure is not limited to the above embodiments. It will be appreciated by those skilled in the art to which the present disclosure pertains that various modifications and changes may be made from the above description.

Therefore, the spirit of the present disclosure shall not be limited to the above-described embodiments, and the entire scope of the appended claims and their equivalents will fall within the scope and spirit of the present disclosure.

What is claimed is:

1. A method of assisting an object control, comprising the steps of:
acquiring a two-dimensional image relating to a user's body from a two-dimensional camera;
calculating three-dimensional real-world coordinates corresponding to at least one body portion among a plurality of body portions of the user, which are specified from the two-dimensional image;
estimating, with reference to the three-dimensional real-world coordinates corresponding to the at least one body portion, three-dimensional real-world coordinates respectively corresponding to a first body portion and a second body portion that are used in determining the user's intention among the plurality of body portions; and
determining a control target area with reference to a first candidate target area specified based on the three-dimensional real-world coordinates respectively corresponding to the first body portion and the second body portion, and a second candidate target area specified based on two-dimensional relative coordinates respectively corresponding to the first body portion and the second body portion in the two-dimensional image,
wherein the control target area is determined on a reference plane established with the two-dimensional camera as a reference.

2. The method of claim 1, wherein the two-dimensional relative coordinates are specified in a relative coordinate system associated with the two-dimensional camera.

3. The method of claim 1, wherein in the calculating step, the three-dimensional real-world coordinates corresponding to the at least one body portion are calculated with reference to a focal length of the two-dimensional camera.

4. The method of claim 1, wherein in the calculating step, the three-dimensional real-world coordinates corresponding to the at least one body portion are calculated with reference to information about a measurement distance between the two-dimensional camera and the user.

5. The method of claim 1, wherein in the calculating step, the three-dimensional real-world coordinates corresponding to the at least one body portion are calculated with reference to information about at least one of a length, a size, and a pixel of at least one object included in the two-dimensional image.

6. The method of claim 1, wherein in the determining step comprises:
specifying at least one instruction line based on the three-dimensional real-world coordinates respectively corresponding to the first body portion and the second body portion; and
specifying the first candidate target area based on the at least one instruction line.

7. The method of claim 1, wherein in the determining step, an area between the two-dimensional camera and a virtual point set on the reference plane is specified as the second candidate target area, and a positional relationship between the virtual point and the two-dimensional camera is specified by a positional relationship between the two-dimensional relative coordinates respectively corresponding to the first body portion and the second body portion in the two-dimensional image.

8. The method of claim 1, wherein in the determining step, an area common to the first candidate target area and the second candidate target area is determined as the control target area.

9. The method of claim 1, wherein in the determining step, an object included in the control target area is determined as an object to be controlled by the user.

10. A non-transitory computer-readable recording medium having stored thereon a computer program for executing the method of claim 1.

11. A system for assisting an object control, comprising:
an image acquisition unit configured to acquire a two-dimensional image relating to a user's body from a two-dimensional camera;
a coordinate estimation unit configured to calculate three-dimensional real-world coordinates corresponding to at least one body portion among a plurality of body portions of the user, which are specified from the two-dimensional image, and configured to estimate, with reference to the three-dimensional real-world coordinates corresponding to the at least one body portion, three-dimensional real-world coordinates respectively corresponding to a first body portion and a second body portion that are used in determining the user's intention among the plurality of body portions; and
a control target area determination unit configured to determine a control target area with reference to a first candidate target area specified based on the three-dimensional real-world coordinates respectively corresponding to the first body portion and the second body portion, and a second candidate target area specified based on two-dimensional relative coordinates respectively corresponding to the first body portion and the second body portion in the two-dimensional image,
wherein the control target area is determined on a reference plane established with the two-dimensional camera as a reference.
